(19) United States
(12) Patent Application Publication
(10) Pub. No.: US 2024/0320775 A1
(43) Pub. Date: Sep. 26, 2024

(54) SYSTEM AND METHOD OF RECOMMENDING BOARDING LOCATION FOR TRANSPORTATION VEHICLE REQUESTED FROM PASSENGER OVER DATA COMMUNICATION NETWORK

(71) Applicant: 42DOT Inc., Seoul (KR)

(72) Inventors: Myung Hyun CHO, Bucheon (KR); Seung Hyun JI, Seoul (KR)

(21) Appl. No.: 18/731,455

(22) Filed: Jun. 3, 2024

Related U.S. Application Data
(62) Division of application No. 17/818,790, filed on Aug. 10, 2022.
(63) Continuation of application No. PCT/KR2021/006893, filed on Jun. 2, 2021.

(30) Foreign Application Priority Data
Jun. 3, 2020 (KR) 10-2020-0067085

(51) Int. Cl. G06Q 50/40; G01C 21/34; G06Q 10/02

(52) U.S. Cl. CPC G06Q 50/40; G01C 21/3415; G06Q 10/02

(57) ABSTRACT

The present disclosure generally relates to a transportation service, and more particularly, a method of recommending a boarding location for a transportation vehicle requested from a passenger over a data communications network, and a management server used therefor. The recommended boarding location allows the passenger to easily board the transportation vehicle by avoiding a pickup location with an obstacle such as a fence. Street view images of the boarding location are also provided to passengers and drivers to help them to quickly find the boarding location.

### CROSS-REFERENCE TO RELATED APPLICATION

This is a Divisional Application of U.S. application Ser. No. 17/818,790 filed Aug. 10, 2022 which is a continuation application of International Patent Application No. PCT/KR2021/006893 filed Jun. 2, 2021, claiming priority based on Korean Patent Application No. 10-2020-0067085, filed Jun. 3, 2020.

### BACKGROUND

On-demand transportation services, such as Kakao Taxi, allow passengers conveniently find a transportation service using their smart phones.

However, there are still problems to be overcome. The specific problem discussed in the present invention is finding a suitable pick-up location when a driver arrives to pick a passenger up. For example, when a passenger requests a transportation service from a location where a transportation vehicle is not easily accessible due to an obstacle such as a fence, the driver and passenger may not find each other at the pickup location, and, consequently, have to schedule a pickup location through a telephone conversation.

Meanwhile, in “Grab” which is an online transportation service widely used in Southeast Asia, multiple boarding locations close to a departure point are presented to the passenger when the passenger determines the departure point. To this end, they maintain information about passenger's travel history and entrance points of a specific location, such as a building.

However, the method of using the passenger's travel history has a limitation that it can be only used for a location with an extensive travel history or for a transportation service provider that has enough customer data. Furthermore, obstacles along a sidewalk are not considered in building recommended pickup locations. In addition, the recommended boarding location is displayed as a point on a map without additional information that would help passengers quickly identify the exact boarding location.

In another instance, “Yandex”, which is an on-demand transportation service provided in Russia, employs a method of providing a passenger with an alternate boarding location if the passenger's current position is not easily accessible by a vehicle.

Their method, however, also has problems that it only improves convenience for a driver because the alternate pick-up locations are selected without considering how convenient the locations would be from passenger's point of view, obstacles are not considered in determining the pick-up location, and the pick-up location is displayed just as a single point on the map.

### BRIEF DESCRIPTION

### Technical Problem

The present disclosure is directed to a method and a system of recommending a boarding location for a transportation vehicle requested from a passenger over a data communication network and a management server used therefor. The recommended boarding location is to increase driver and passenger convenience by avoiding a location where the passenger may not board the vehicle easily due to obstacles such as fences. Street view images of a boarding location are also provided to passengers and drivers to help them to quickly find the boarding location.

### Solution

According to aspects of the present disclosure, there is provided a method and a system of recommending a boarding location of a transportation vehicle requested from a passenger over a data communications network, the method and the system include determining, by the management server, a recommended boarding location on the basis of the location information about the departure point; determining, by the management server, a driver's street view image and a passenger's street image using the recommended boarding location, transmitting, by the management server, the recommended boarding location and the driver's street view image to a driver's device and the recommended boarding location and the passenger's street view image to the passenger's device; wherein the recommended boarding location is in a boarding allowed zone where an obstacle between the passenger and the vehicle does not exist.

### Advantageous Effects

According to the present disclosure, it is possible to improve passenger convenience by recommending a suitable boarding location with street view images. The suitable boarding location allows passengers easily ride in a vehicle at the boarding location by avoiding locations with an obstacle, such as a fence.

In addition, according to the present disclosure, street view images of a boarding location are presented to a driver and a passenger to help them to quickly locate the boarding location.

### BRIEF DESCRIPTION OF DRAWINGS

FIG. 1 illustrates a concept of recommending a boarding location of a transportation vehicle requested from a passenger over a data communication network according to an embodiment of the present disclosure.

FIG. 2 illustrates an exemplary system architecture for implementing various embodiments of the present disclosure.

FIG. 3 is a functional block diagram showing a structure of a management server configured to execute the method of recommending a boarding location of a transportation vehicle according to an embodiment of the present disclosure.

FIG. 4 is a sequence diagram showing an execution process of recommending a boarding location according to an embodiment of the present disclosure.

FIG. 5 is a flowchart showing an execution process of selecting a recommended boarding location according to an embodiment of the present disclosure.

FIG. 6 is a conceptual view illustrating the method of selecting a recommended boarding location according to an embodiment of the present disclosure.

FIG. 7 is a flowchart showing the process of selecting a street view image for a driver according to an embodiment of the present disclosure.

FIG. 8 is a conceptual view illustrating the process of selecting a street view image for a driver according to an embodiment of the present disclosure.

FIG. 9 is an exemplary street view image created for a passenger according to an embodiment of the present disclosure.

FIG. 10A-10C depict the process of obtaining a street view image by a management server according to an embodiment of the present disclosure.

FIG. 11 is a block diagram of a management server according to an embodiment of the present disclosure.

### DETAILED DESCRIPTION

Hereinafter, the present disclosure will be described in detail with reference to the drawings. It should be noted that the same components are represented by the same reference numerals in the drawings. In addition, a detailed description of known functions and configurations that may unnecessarily obscure the gist of the present disclosure will be omitted.

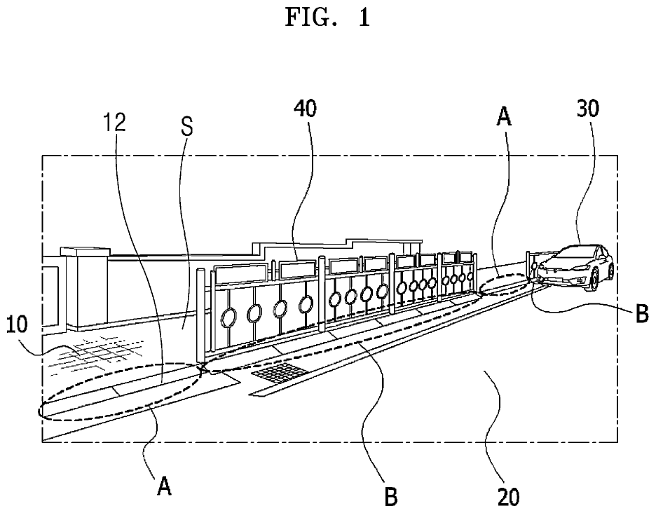

FIG. 1 illustrates a concept of recommending a boarding location of a transportation vehicle requested from a passenger over a data communication network according to an embodiment of the present disclosure. A passenger who has requested a transportation vehicle 30 typically waits for the vehicle 30 on a sidewalk 10.

Meanwhile, in an area where the passenger waits for the vehicle 30, there may be a no-boarding zone B in which the vehicle 30 is not accessible due to an obstacle 40. For example, when the passenger is located in the no-boarding zone B, the passenger is not able to board the vehicle 30.

Accordingly, the present invention proposes a method of guiding the passenger to a boarding allowed zone A from the no-boarding zone B when the departure point S designated by a passenger is in the no-boarding zone B.

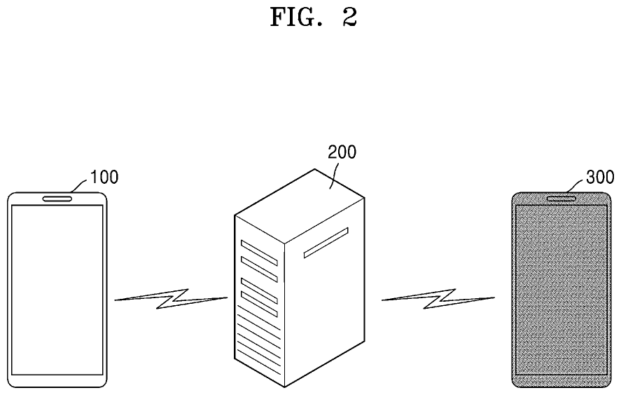

FIG. 2 illustrates an exemplary system architecture for implementing various embodiments of the present disclosure. Referring to FIG. 2, the system for recommending a boarding location may include a passenger device 100, a management server 200, and a driver device 300. The driver provides a transportation service requested from the passenger.

An application program for the passenger may be installed in the passenger device 100, and an application program for the driver may be installed in the driver device 300. These application programs are capable of sending and receiving data over a wireless network.

Meanwhile, in implementing the present disclosure, the driver device 300 may also work as a communication device for supporting vehicle operations, such as a navigation device in the vehicle 30.

The management server 200 is a server operated by an on-demand transportation service provider for recommending a boarding location of a transportation vehicle. The management server 200 receives location information associated with the departure point S from the passenger device 100, determines one or more recommended boarding location R on the basis of the location information of the departure point S, transmits the one or more recommended boarding location to the passenger device 100, may receive a selected recommended boarding location R from the passenger device 100, searches for a street view image corresponding to the boarding location R, and transmits the street view image to the passenger device 100 and the driver device 300 of the vehicle 30.

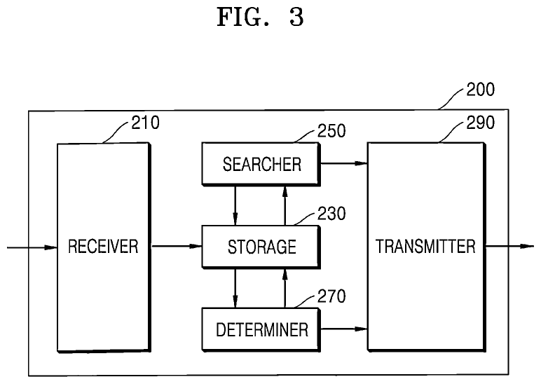

FIG. 3 is a functional block diagram showing a structure of a management server 200 configured to execute the method of recommending a boarding location of a transportation vehicle according to an embodiment of the present disclosure. Referring to FIG. 3, the management server 200 may include a receiver 210, a storage 230, a searcher 250, a determiner 270, and a transmitter 290.

The receiver 210 of the management server 200 receives a departure point and a selected boarding location from the passenger device 100.

The storage 230 of the management server 200 stores images of a service area in the form of a panoramic 360-degree view, information about all sidewalks 10, information about boarding allowed zones A (no obstacle exists) and no-boarding zones B (obstacles exist) for each of the sidewalks 10, and information about all roadways 20.

Meanwhile, in implementing the present disclosure, the storage 230 may be implemented as a remote database server that is connected to the management server 200. The searcher 250 of the management server 200 performs two searches in a row for sidewalks 10. First, it searches for the sidewalks 10 around the departure point S designated by the passenger. Second, it searches for the sidewalks 10 adjacent to the roadway 20 from the sidewalks 10 found in the first search. The searcher 250 also searches for a street view image corresponding to the recommended boarding location R.

The determiner 270 of the management server 200 determines the recommended boarding location R on the basis of the passenger's departure point S.

In an embodiment, the determiner 270 first selects, among the sidewalks 10 found by the second search of the searcher 250, the nearest sidewalk 10 from the departure point S. Then, it determines whether the departure point S is included in the boarding allowed zone A located on the selected sidewalk 10. If the departure point S is included in the boarding allowed zone A, the departure point S becomes a recommended boarding location R. Otherwise, the determiner 270 selects an alternate recommended boarding location.

In another embodiment, the determiner 270 may select the sidewalk 10 in consideration of real-time traffic data in addition to the distance between the departure point S and the sidewalks 10. For example, although the distance from the departure point S to a sidewalk sₐ is closer to another sidewalk s_{b}, the determiner 270 may select the sidewalk s_{b} instead of the sidewalk sₐ if it takes less time for the vehicle to arrive at s_{b} under the given real-time traffic condition.

The transmitter 290 of the management server 200 transmits the recommended boarding location determined by the determiner 270 and the street view images searched by the searcher 250 to the passenger device 100 and driver device 300.

Meanwhile, storage 230 of the management server 200 stores data transmission history of the receiver 210, search history of the searcher 250, determination history of the determiner 270, and data transmission history of the transmitter 290.

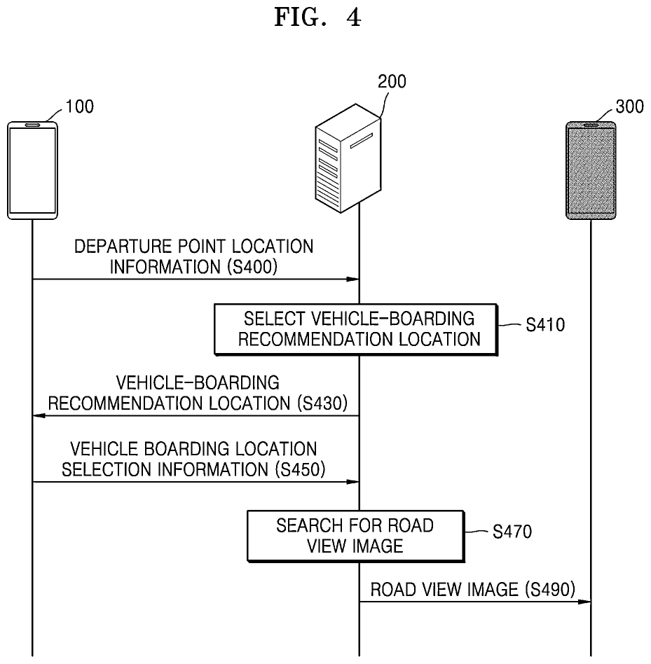

FIG. 4 is a sequence diagram showing an execution process of recommending a boarding location according to an embodiment of the present disclosure. Hereinafter, the execution process will be described with reference to FIGS. 1 to 4.

First, to request the transportation vehicle 30, the passenger executes the application program installed on the passenger device 100 and then may select the departure point S on a map displayed on a screen of the passenger device 100. The management server 200 receives the passenger's departure point from the passenger device 100 (S400).

In another embodiment, the passenger's departure point S can be automatically selected from the current location of the passenger device 100.

Meanwhile, the management server 200 selects a recommended boarding location R based on the passenger's departure point received from the passenger device 100 (S410).

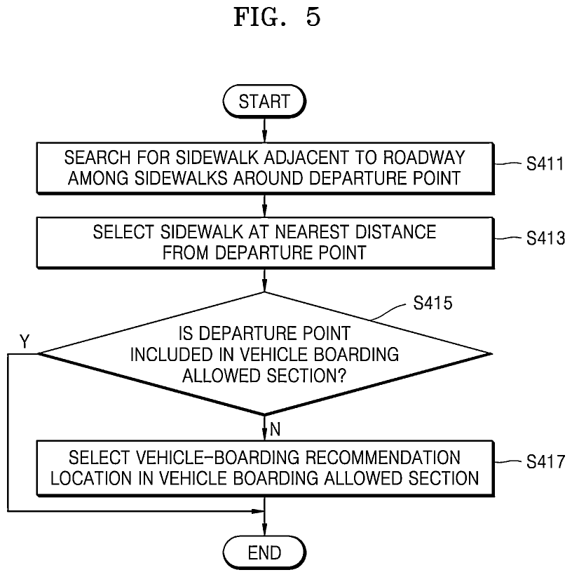

FIG. 5 is a flowchart showing an execution process of selecting a recommended boarding location according to an embodiment of the present disclosure. Referring to FIG. 5, the searcher 250 of the management server 200 first searches for sidewalks 10 within a predetermined radial distance (e.g., 100 m) from the location coordinates of the departure point S, and then it conducts a second search, from the list of sidewalks returned from the first search, to find sidewalks 10 adjacent to a roadway 20. (S411).

The determiner 270 of the management server 200 selects, among the sidewalks 10 found by the searcher 250, the nearest sidewalk 10 from the departure point S (S413), and determines whether the location coordinates of the departure point S is included in a boarding allowed zone A on the selected sidewalk 10 (S415). If the departure point S is included in the boarding allowed zone A, the departure point S becomes a recommended boarding location.

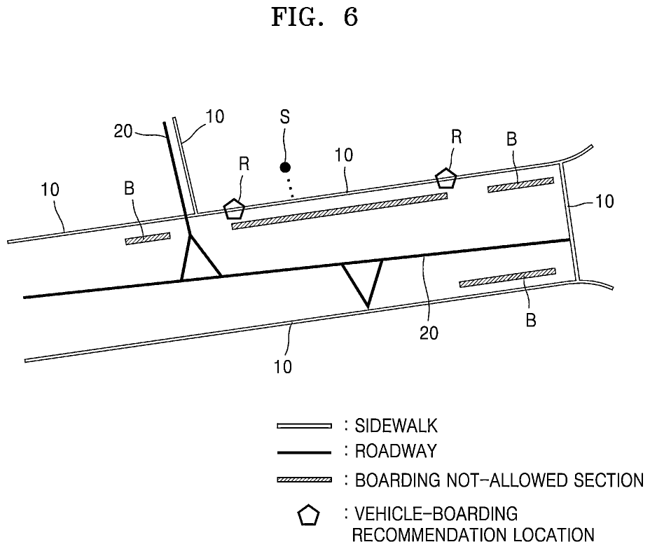

As shown in FIG. 6, if the location of the departure point S is included in a no-boarding zone B, the determiner 270 of the management server 200 may find boarding allowed zones A located at the (left and right) sides of the no-boarding zone B along a sidewalk. A plurality of points close to the intersection points where the boarding allowed zones A meet the no-boarding zone B are selected. The plurality of points is transmitted to the passenger as possible boarding locations (S430). The passenger may select one point of the plurality of points as the recommended boarding locations R.

Then, the searcher 250 of the management server 200 searches for each street view image from the plurality of recommended boarding locations R. The transmitter 290 of the management server 200 transmits the plurality of street view images for each recommended boarding location to the passenger device 100 (S430).

Accordingly, the passenger may view the plurality of recommended boarding locations R with the street view images using the passenger device 100, select one recommended boarding locations R, move to the selected boarding location, and wait for the requested vehicle 30.

Meanwhile, instead of creating the plurality of recommended boarding locations, the determiner 270 of the management server 200 may select a point closest to the departure point of the passenger for the recommended boarding location R without requiring the selection process by the passenger.

After the passenger selects one recommended boarding locations R through the passenger device 100, the management server 200 receives a selected boarding location from the passenger device 100 (S450), and the management server 200 searches for the street view image for the driver (S470).

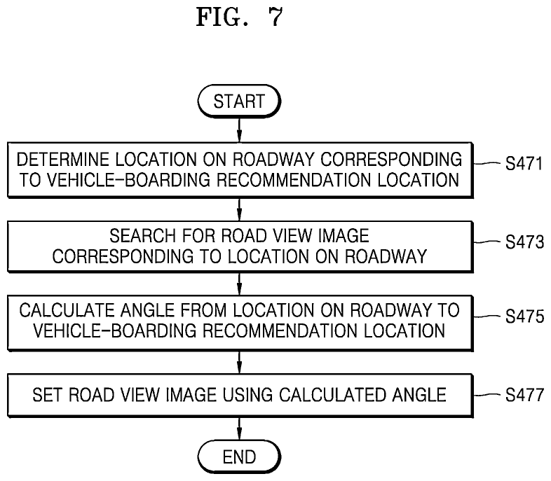

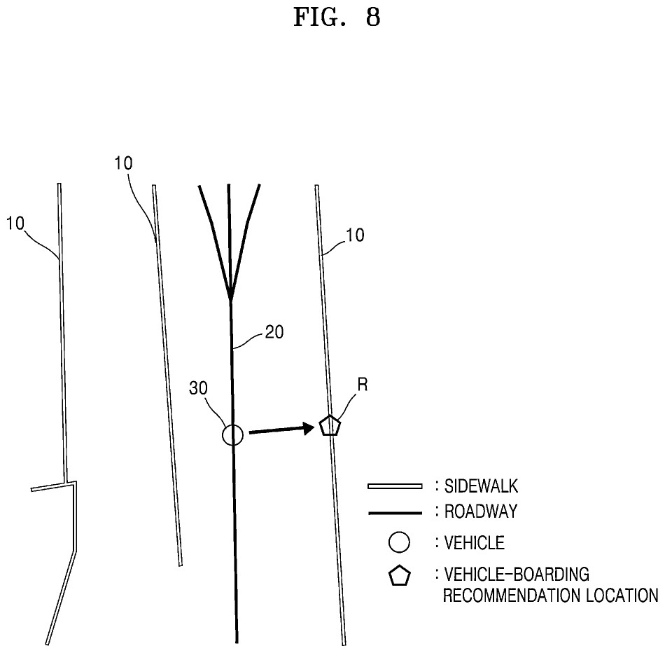

FIG. 7 is a flowchart showing the process of selecting a street view image for a driver according to an embodiment of the present disclosure. Referring to FIG. 7, first, the searcher 250 of the management server 200 searches for the roadway 20 adjacent to the sidewalk that includes the recommended boarding location selected by the passenger, and the determiner 270 determines the location coordinates of the roadway 20 on which the vehicle 30 stops to pick up the passenger as shown in FIG. 8.

Next, the searcher 250 of the management server 200 searches for the 360-degree street view image using the location coordinates of the determined roadway 20 from the storage 230 (S473), and at the same time, the determiner 270 of the management server 200 calculates a direction angle from the location coordinates of the roadway 20 to the coordinates of the boarding location selected by the passenger in operation S450 (S475).

Thereafter, the determiner 270 of the management server 200 generates the street view image from the 360-degree street view image searched in operation S473 using the direction angle calculated in operation S475. The street view image is an image facing a boarding location when the vehicle is stopped to pick the passenger up.

Meanwhile, when the management server 200 receives a selected boarding location from the passenger device 100 in operation S450, the management server 200 may modify the departure point entered by the passenger in operation S400 to the boarding location selected by the passenger in operation S450, and broadcast the modified transportation request to the driver device 300 of the vehicle 30 located within a predetermined radial distance of the departure point S.

Thereafter, the management server 200 may transmit the street view image created in operation S470 to the corresponding driver device 300 along with the boarding location information selected by the passenger (S490).

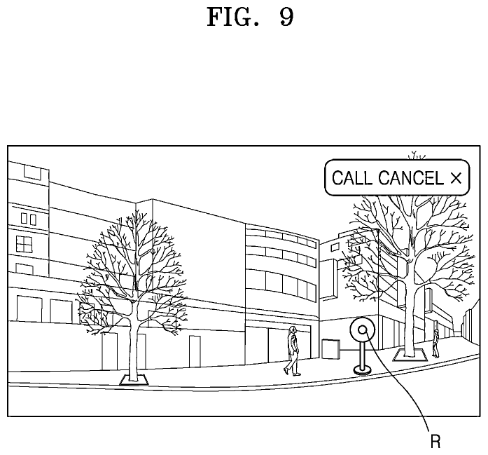

Accordingly, the driver may see the street view image facing the boarding location when the driver stops to pick up the passenger through a screen of the driver device 300 as shown in FIG. 9. This allows the driver to easily identify the boarding location selected by the passenger.

Meanwhile, when the recommended boarding location is not suitable for picking up the passenger due to an unexpected road condition such as a road construction when the driver arrives at the boarding location, the driver needs to request a boarding location change.

In this case, as shown in FIG. 9, the driver may select a “call cancel” button or a “boarding location change” button (not shown) that are displayed on the screen of the driver device 300 with the street view image. The management server 200 may receive a request for changing the boarding location from the driver device 300.

When the request for changing the boarding location is received from the driver device 300, the determiner 270 of the management server 200 may change the vehicle boarding location with a recommended boarding location R not selected in operation S410, and transmit a vehicle boarding location change message including a new boarding location and a new street view image corresponding to the new location to the passenger device 100 and the driver device 300.

In this case, the street view image transmitted to the driver device 300 may be the street view image facing the new boarding location.

In addition, in implementing the present disclosure, when the passenger who has selected the boarding location in operation S450 finds it not suitable for riding in the vehicle due to an unexpected road construction, the passenger may select another recommended boarding location from the plurality of recommended boarding locations R received in operation S430.

Accordingly, the management server 200 receives boarding location change request from the passenger device 100, and thereafter, the management server 200 performs operations S470 and S490 again.

Meanwhile, in implementing the present disclosure, when the determiner 270 of the management server 200 determines that the location coordinates of the departure point S are included in the boarding allowed zone A on the sidewalk 10 in operation S415, the management server 200 may not perform operations S430 and S450, and may perform operations S470 and S490 after determining the location coordinates of the departure point S as the recommended boarding location R.

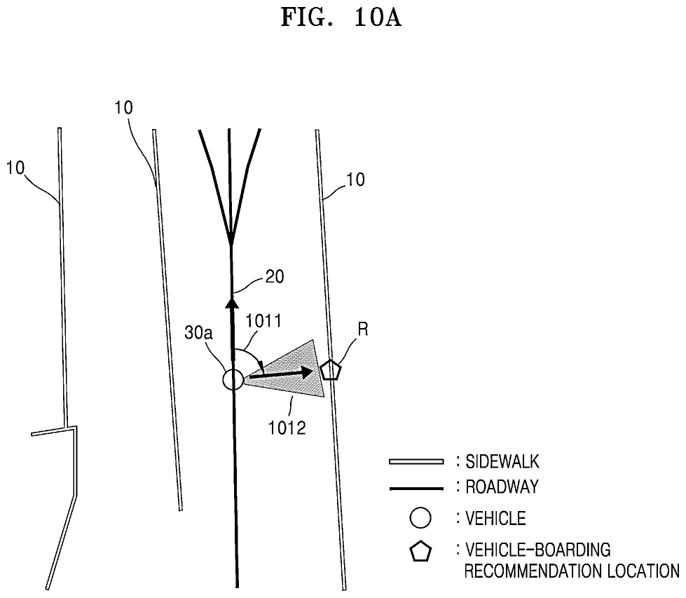

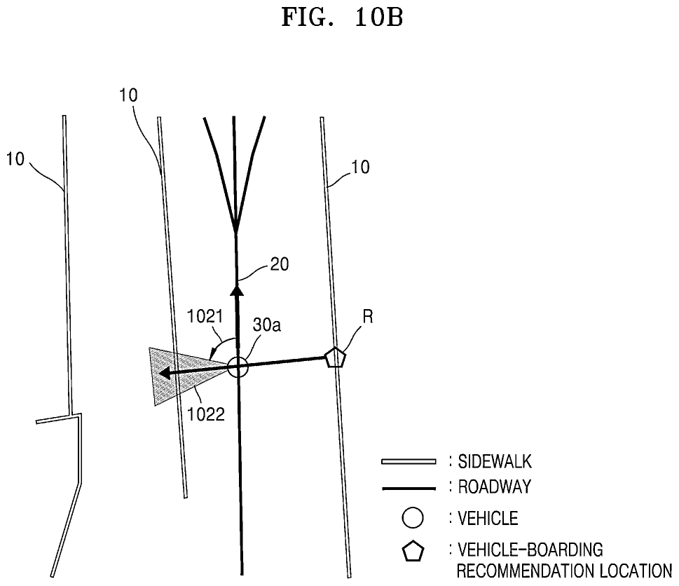

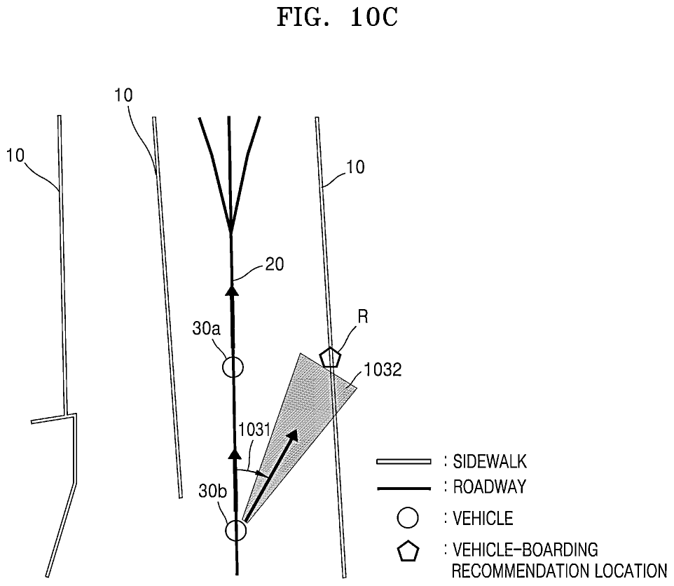

FIGS. 10A to 10C depict the process of obtaining a street view image by a management server according to an embodiment.

Referring to FIG. 10A, the management server 200 may receive location information about a departure point from the passenger device 100. In addition, the management server 200 may select a recommended boarding location R on the basis of the location information about the departure point.

The management server 200 may determine a passenger pickup location 30a on a roadway based on the recommended boarding location R. For example, the management server 200 may determine the point having a distance closest to the recommended boarding location R on the roadway using positional data (e.g., Global Positioning System (GPS) coordinate information).

Then, the management server 200 may calculate a first angle 1011 facing the recommended boarding location R from the location 30a. For example, the first angle 1011 may be an angle between a straight line trajectory describing motion of vehicle 30a and another line created by rotating the straight line clockwise until the line meets the recommended boarding location R.

The management server 200 may obtain a first street view image 1012 corresponding to the calculated first direction angle 1011. For example, the management server 200 may retrieve a panoramic 360° street view image captured at the location 30a from the storage 230, and may obtain a street view image captured at an angle of a predetermined range (e.g., +/−30°, +/−45°, +/−60°, and the like) with respect to the first angle 1011 as the first street view image 1012.

The management server 200 may transmit the first street view image 1012 to the driver device 300 of the vehicle 30.

The management server 200 according to the present disclosure transmits the first street view image 1012 corresponding to the first direction angle 1011, which faces the recommended boarding location R from the location 30a on the roadway, to the driver device 300

Referring to FIG. 10B, the management server 200 may receive location information about a departure point from the passenger device 100. In addition, the management server 200 may select the recommended boarding location R on the basis of the location information about the departure point.

The management server 200 may calculate a second angle 1021 facing the location 30a from the recommended boarding location R on the basis of the information about the recommended boarding location R and information about the location 30a on the roadway. For example, the second angle 1021 may be an angle between a straight line trajectory describing motion of vehicle 30a and another line created by rotating the straight line counter-clockwise until the line meets the recommended boarding location R.

The management server 200 may obtain a second street view image 1022 corresponding to the calculated second angle 1021. For example, the management server 200 may retrieve a panoramic 360° street view image captured at the location 30a from the storage 230, and may obtain a street view image captured at an angle of a predetermined range (e.g., +/−30°, +/−45°, +/−60°, and the like) with respect to the second angle 1021 as the second street view image 1022.

In an embodiment, the management server 200 may transmit the second street view image 1022, which faces the location 30a on the roadway from the recommended boarding location R, to the passenger device 100.

In another embodiment, the management server 200 may obtain an additional street view image, that is different from the second street view image 1022, from the 360° street view images captured at the location 30a on the roadway. For example, the management server 200 may obtain an additional street view image whose image capturing angle is different from that of the second street view image 1022. For example, the image capturing angle is 180° which is wider than the angle of the second street view.

A composite street view image in which the second street view image 1022 and the additional street view image are overlaid may be generated. The management server 200 may transmit the composite street view image to the passenger device 100.

Since there is a slight difference between the recommended boarding location R and the location 30a on the roadway, the management server 200 according to the present disclosure may provide the passenger with a street view image that matches a foreground in an eye gaze direction in which the passenger is looking at the recommended boarding location R by obtaining the additional street view image in addition to the second street view image 1022, and generating the composite street view image.

Referring to FIG. 10C, the management server 200 may receive location information about a departure point from the passenger device 100, and may select the recommended boarding location R on the basis of the location information about the departure point.

In addition, the management server 200 may obtain a vehicle movement direction, on which the vehicle travels until the vehicle stops, on the basis of the information about the recommended boarding location R.

The management server 200 may calculate a third direction angle 1031 facing the location 30a on the roadway from an arbitrary location 30b on the basis of the recommended boarding location R and the vehicle movement direction information at the arbitrary location 30b.

For example, the angle 1031 may be an angle between the vehicle movement direction and the recommended boarding location R.

In an embodiment, the arbitrary location 30b determined by the management server 200 may be located at a predetermined distance away from the location 30a or at a position where the vehicle 30 takes a predetermined amount of time to arrive at the location 30a. A plurality of arbitrary locations 30b may be provided.

The management server 200 may obtain a third street view image 1032 corresponding to the calculated third angle 1031. For example, the storage 230 may store a 360-degree image captured at the arbitrary location 30b, and the management server 200 may obtain a street view image captured at an angle of a predetermined range (e.g., +/−30°, +/−45°, +/−60°, and the like) with respect to the third direction angle 1031 as the third street view image 1032.

In an embodiment, the management server 200 may transmit the third street view image 1032 to the passenger device 100 even before the vehicle 30 stops at the location 30a on the roadway.

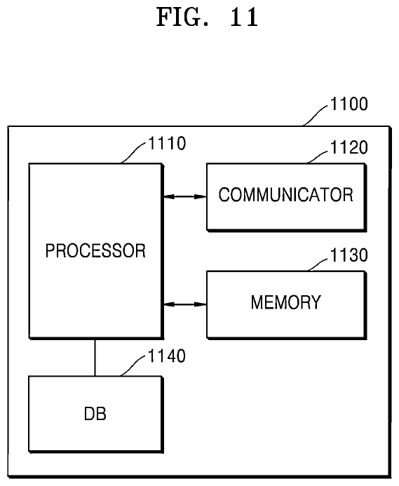

FIG. 11 is a block diagram of a management server according to an embodiment.

Referring to FIG. 11, a management server 1100 may include a processor 1110, a communicator 1120, memory 1130, and an DB 1140. Only components related to the embodiment are illustrated in the management server 1100 of FIG. 11. Accordingly, it will be appreciated to those skilled in the art that other general components may be further included in addition to the components illustrated in FIG. 11.

The communicator 1120 may include one or more components that enable wired/wireless communication with an external server or an external device. For example, the communicator 1120 may include at least one of a short-range communicator (not shown), a mobile communicator (not shown), and a broadcast receiver (not shown).

The receiver 210 and the transmitter 290, which are described in FIG. 2, may be implemented using the communicator 1120.

The DB 1140 may be hardware for storing various types of data processed in the management server 1100. The DB 1140 may store payment information, user information, image data and the like. The DB 1140 may have its own processor (not shown) and memory (not shown) to process operations regarding data access, such as reading and writing image data. The storage 230 described above in FIG. 2 may be implemented using the DB 1140.

The management server 1100 may include a memory 1130 such as a dynamic random access memory (DRAM), a static random access memory (SRAM), or the like, a read-only memory (ROM), an electrically erasable programmable ROM (EEPROM), a compact-disc read-only memory (CD-ROM), a Blue-ray or other optical disk storage, a hard disk drive (HDD), a solid state drive (SSD), or a flash memory. The memory 1130 may store programs for processing and controlling the processor 1110.

The processor 1110 controls the overall operation of the management server 1100. For example, the processor 1110 may control an input part (not shown), a display (not shown), the communicator 1120, the memory 1130, the DB 1140, and the like by executing the programs stored in the memory 1130.

The processor 1110 may be implemented using at least one of application-specific integrated circuits (ASICs), digital signal processors (DSPs), digital signal processing devices (DSPDs), programmable logic devices (PLDs), field-programmable gate arrays (FPGAs), microprocessors, and electrical units for performing other functions.

The processor 1110 may control at least some of the operations of the management server 1100 described above with reference to FIGS. 1 to 10. The searcher 250 and the determiner 270, which are described above in FIG. 2, may be implemented using the processor 1110.

In an embodiment, the management server 1100 may be a server located outside the vehicle 30. The server may be implemented as a computer device or a plurality of computer devices that communicate over a network to provide instructions, codes, files, content, services, and the like. The server may receive necessary data to determine a current lane, in which a vehicle is traveling, from devices mounted in the vehicle, and determine the current lane in which the vehicle is running on the basis of the received data.

In another embodiment, the management server 1100 may be implemented as an electronic device embedded in the vehicle 30. For example, the management server 1100 may be implemented as an electronic device that is inserted into the vehicle 30.

In another embodiment, the management server 1100 may be implemented using a mobile electronic device. For example, the management server 1100 may be implemented as a smartphone, a tablet personal computer (PC), a PC, a smart TV, a personal digital assistant (PDA), a laptop computer, a media player, a navigation system, a device in which a camera is mounted, and other mobile electronic devices. In addition, the management server 1100 may be implemented using a wearable device such as a watch, glasses, a hair band, and a ring having a communication function and a data processing function.

In addition, the present disclosure may be performed in a state in which a program for executing each operation of the method of recommending a boarding location according to an embodiment of the present disclosure as described above is installed in the storage 230 of the management server 200, and the corresponding program may be used while being recorded in a computer-readable recording medium.

The terms used herein are for the purpose of describing particular exemplary embodiments only and are not intended to be limiting to the present disclosure. As used herein, singular forms are intended to include plural forms as well, unless the context clearly indicates otherwise. In the present application, it will be further understood that the terms “comprise,” “comprising,” “include,” and/or “including”, when used in this specification, specify the presence of stated features, integers, steps, operations, elements, components and/or groups thereof but do not preclude the presence or addition of one or more other features, integers, steps, operations, elements, components and/or groups thereof.

While exemplary embodiments and applications of the present disclosure have been illustrated and described, the present disclosure is not to be construed as limited to the particular embodiments and applications described above, and it will be understood that various modifications may be made without departing from the spirit and scope of the present disclosure and such modifications are not individually understandable from the present disclosure.

What is claimed is:

1. A system for providing a boarding location, including a passenger mobile device, a management server, and a driver navigation device, comprising:
the passenger mobile device having:
a mobile device screen configured to display a map including a plurality of roadways and a plurality of sidewalks, and
a mobile device network interface configured to transmit information on a departure location on one sidewalk from the displayed plurality of sidewalks to the management server;
the management server having:
a storage storing the map including the plurality of roadways and the plurality of sidewalks;
a server network interface configured to receive the information on the departure location and transmit a first partial panoramic view image to the passenger mobile device and a second partial panoramic view image to the driver navigation device,
a server processor configured to generate candidate boarding locations searched from the map based on the information on the departure location and generate the first partial panoramic view image and the second partial panoramic view image based on one selected boarding location selected from the candidate boarding locations,
wherein the first partial panoramic view image and the second partial panoramic view image are generated from a first panoramic 360-degree street view image captured at a roadway location according to a first angle of a first predetermined range and a second angle of a second predetermined range, respectively, the roadway location being a location on one roadway from the plurality of roadways corresponding to the one selected boarding location selected from the candidate boarding locations; and
the driver navigation device, installed in a vehicle, having:
a navigation network interface configured to receive the second partial panoramic view image from the server network interface, and
a navigation screen configured to display the second partial panoramic view image,
wherein the mobile device network interface is further configured to receive the first partial panoramic view image from the server network interface and the mobile device screen is further configured to display the first partial panoramic view image,
wherein the server processor is further configured to generate a third partial panoramic view image from a second 360-degree street view image captured at a position located at a predetermined distance away from the one selected boarding location or at a position where the vehicle requires a predetermined amount of time to arrive at the one selected boarding location,
wherein the third partial panoramic view image is transmitted to the navigation network interface of the driver navigation device and displayed on the navigation screen of the driver navigation device.

2. The system of claim 1, wherein the navigation screen displays a boarding location change button.

3. The system of claim 2, wherein, upon an activation of the boarding location change button,
the server network interface receives a signal for a boarding location change request from the driver navigation device,
the server processor selects a new boarding location, different from the one selected boarding location and generates a new street view image corresponding to the new boarding location, and
the server network interface transmits a vehicle boarding location change message including the new boarding location and the new street view image to the passenger mobile device and the driver navigation device.

4. The system of claim 3, wherein the mobile device screen of the passenger mobile device and the navigation screen of the driver navigation device display the new street view image corresponding to the new boarding location.

5. The system of claim 1, wherein the first angle of the first predetermined range is determined based on an angle between a linear path of a motion of a vehicle and a first line formed by rotating the linear path counter-clockwise until the first line intersects the one selected boarding location, and the angle of the second predetermined range is determined based on an angle between the linear path and a second line formed by rotating the linear path clockwise until the second line intersects the one selected boarding location.

6. The system of claim 1, wherein the server processor is further configured to generate a fourth partial panoramic view image, wherein the fourth partial panoramic view image is generated from the first panoramic 360-degree street view image and has a third angle of a third predetermined range that is wider than the first angle.

7. A navigation device for providing a boarding location, the navigation device comprising:
a network interface for data communication,
a processor for a data processing,
a display for displaying an image, and
a storage storing sidewalk information for each of a plurality of sidewalks, with the sidewalk information comprising a position of an obstacle between a sidewalk of the plurality of sidewalks and its adjacent roadway, an endpoint information of the sidewalk, and a street view image of the sidewalk,
wherein the network interface is configured to receive a location coordinate of a passenger determined based on Global Positioning System (GPS) coordinate information and real-time traffic information;
wherein the processor is configured to:
determine a nearest sidewalk from the plurality of sidewalks based on the location coordinate and a vehicle's arrival time to the location coordinate, with the nearest sidewalk being located within a predetermined radial distance from the location coordinate and the vehicle's arrival time being determined by the real-time traffic information,
determine a boarding location coordinate on the nearest sidewalk, with the boarding location coordinate being either an obstacle free location on the nearest sidewalk or one of two locations located at both ends of the nearest sidewalk if the obstacle free location does not exist on the nearest sidewalk, and
convert the boarding location coordinate into a boarding location image by capturing a predetermined range facing the boarding location coordinate from the street view image,
wherein the display is configured to display the boarding location image.

8. The navigation device of claim 7, wherein the network interface is further configured to receive a selected boarding location coordinate selected from a map displayed on a mobile device of the passenger.

9. The navigation device of claim 8, wherein the processor is further configured to generate an additional boarding location image corresponding to the selected boarding location coordinate.

10. The navigation device of claim 7, wherein the predetermined range is determined based on an angle between a linear path of a motion of the vehicle and a line formed by rotating the linear path clockwise until the line intersects the boarding location coordinate.

11. The navigation device of claim 7, wherein the display displays a boarding location change button within the boarding location image.

12. The navigation device of claim 11, wherein, upon an activation of the boarding location change button, the navigation device determines a new boarding location coordinate, generates a new boarding location image facing the new boarding location coordinate, and transmits the new boarding location image to the mobile device of the passenger.
